(19) United States
(12) Patent Application Publication
(10) Pub. No.: US 2023/0206762 A1
(43) Pub. Date: Jun. 29, 2023

(54) VEHICLE CONTROL SYSTEM

(71) Applicant: Transportation IP Holdings, LLC, Norwalk, CT (US)

(72) Inventors: Bridget Lee Taylor, Erie, PA (US); Mark Robert Cozzens, St. Johns, FL (US); Steven Paul Loncher, Holly Springs, NC (US); Christopher M. McQuown, Erie, PA (US); Jason Daniel Quigley, Erie, PA (US); Glenn Robert Shaffer, Erie, PA (US)

(21) Appl. No.: 17/645,873

(22) Filed: Dec. 23, 2021

(51) Int. Cl. G08G 1/127; G07C 5/00; G01C 21/36; G05B 13/04; G05B 13/02

(52) U.S. Cl. CPC G08G 1/127; G07C 5/008; G01C 21/3691; G05B 13/048; G05B 13/0265

(57) ABSTRACT

A system and method include a controller configured to obtain or receive a predicted weather event along a route during a current or upcoming trip based on weather data. The controller determines a weather fitness of a first vehicle for traveling on the route during the trip based on the predicted weather event and equipment characteristics of equipment disposed onboard the first vehicle. The controller assigns one of the first vehicle or a different, second vehicle to complete the trip based at least in part on the weather fitness of the first vehicle.

### BACKGROUND

### Technical Field

The subject matter described herein relates to systems and methods that evaluate and control vehicles based on weather-related conditions.

### Discussion of Art

Weather conditions can affect the performance of vehicles traveling on a route for a trip and/or can negatively impact the route. For example, wet and/or icy conditions can cause a vehicle to experience stalls, delays, wheel slippage, loss of control due to reduced adhesion between the vehicle and the route, damage to the route, etc. In another example, cold temperatures and heavy snow can adversely affect the operation of certain pieces of equipment onboard a vehicle, such as an air compressor, a radiator fan, batteries (e.g., due to the temperature being too cold or hot to allow for the batteries to charge and/or discharge to desirable levels), etc. Weather conditions have varying impacts on different pieces of equipment, such that one piece of equipment may be degraded or inhibited by a certain weather condition while another piece of equipment is unaffected. Two different vehicles may have different equipment onboard, so one vehicle may be better equipped to handle inclement weather conditions than the other vehicle based on the specific equipment and weather condition.

A transportation fleet manager may assign vehicles to complete different trips or missions. When scheduling trips, the manager may attempt to select the most capable and reliable vehicles to perform the highest priority trips, because such vehicles are least likely to experience a equipment failure and/or fail to complete the trip at a scheduled time. Weather conditions affect the capability and reliability of the vehicles, but weather data appears to be used only sparingly, if at all, for managing vehicle trips. For example, a weather forecast may be used to plan a trip by scheduling the trip to avoid inclement weather, either by time or location. But known systems do not evaluate the impact of forecasted weather conditions on individual vehicles or determine the different impacts of forecasted weather conditions on the individual vehicles. By not factoring individualized impacts of weather-related conditions on vehicles, a fleet manager may unknowingly select a first vehicle to perform a trip, even though the first vehicle is actually less capable and reliable in the weather than an available second vehicle. As a result, the selected first vehicle may be more likely to experience equipment failure and/or delay during the trip than if the second vehicle was assigned to complete the trip. It may be desirable to have a system and method that differs from those that are currently available.

### BRIEF DESCRIPTION

In one or more embodiments, a controller is provided that includes one or more processors. The controller is configured to obtain or receive a predicted weather event along a route during a current or upcoming trip based on weather data. The controller is configured to determine a weather fitness of a first vehicle for traveling on the route during the trip based on the predicted weather event and equipment characteristics of equipment disposed onboard the first vehicle. The controller is configured to assign one of the first vehicle or a different, second vehicle to complete the trip based at least in part on the weather fitness of the first vehicle.

In one or more embodiments, a method is provided (e.g., a method for evaluating and controlling one or more vehicles based on inclement weather events). The method includes obtaining or receiving a predicted weather event along a route during a current or upcoming trip based on weather data, and determining, via one or more processors, a weather fitness of a first vehicle for traveling on the route during the trip based on the predicted weather event and equipment characteristics of equipment disposed onboard the first vehicle. The method also includes assigning one of the first vehicle or a different, second vehicle to complete the trip based at least in part on the weather fitness of the first vehicle.

In one or more embodiments, a system is provided including a controller that has one or more processors. The controller obtains or receives a predicted weather event along a route during a trip based on weather data and trip parameters, and determines a weather fitness of a vehicle for traveling on the route during the trip based on the predicted weather event and equipment characteristics of equipment disposed onboard the first vehicle. The weather fitness indicates a predicted ability of the vehicle to avoid at least one of an equipment failure or a delay when performing the trip. The controller assigns the vehicle to complete the trip based at least in part on the weather fitness of the vehicle. During the trip, responsive to determining a different, second predicted weather event that the vehicle is expected to experience during the trip, the controller is configured to generate a control signal to one or more of modify movement parameters of the first vehicle, change the route of the trip, modify operation of at least one piece of the equipment onboard the first vehicle, notify an operator of the vehicle about the second predicted weather event, or instruct the operator to install auxiliary equipment on the vehicle.

### BRIEF DESCRIPTION OF THE DRAWINGS

The inventive subject matter may be understood from reading the following description of non-limiting embodiments, with reference to the attached drawings, wherein below:

FIG. 1 is a diagram of a vehicle evaluation and control system according to an embodiment;

FIG. 2 is a schematic illustration of a vehicle evaluation and control system according to an embodiment;

FIG. 3 depicts a vehicle weather fitness (VWF) table according to an embodiment; and

FIG. 4 is a flow chart of a method for evaluating and controlling one or more vehicles based on inclement weather events according to an embodiment.

### DETAILED DESCRIPTION

One or more embodiments described herein are directed to a system and method for evaluating and controlling vehicles based on weather events. The vehicle evaluations include analyzing the suitability of one or more available vehicles for performing a particular mission or trip which would expose the vehicle to at least one weather event. The terms mission and trip are interchangeably used herein, as the missions refer to assigned or scheduled trips of vehicles along routes. The weather event refers to inclement weather and/or weather-related conditions that could affect the performance of equipment onboard a vehicle. Examples of weather events may include hot and cold ambient temperatures, rain, snow, ice (e.g., sleet, hail, etc.), high wind, high and low humidity, flooding, debris accumulation on the route, particulate (e.g., sand and dust) storms, and the like.

In an embodiment, the system and method controls the vehicles by assigning specific vehicles to perform different specific missions based on the vehicle evaluations. For example, the system and method may select a first vehicle to perform a first mission, where it is expected that the first vehicle will travel through an ice storm during the first mission. The first vehicle may be selected instead of a second vehicle because the first vehicle is evaluated to be better suited for reliably traveling through the ice storm without experiencing equipment failure or delay than the second vehicle. The suitability of a vehicle for different types of weather is affected by characteristics of onboard equipment of the vehicles. The suitability is referred to herein as a weather fitness or readiness. The evaluation of the type of weather (e.g., ice storm) and the onboard equipment may determine that the first vehicle has a greater weather fitness for performing the first mission than the second vehicle, so the first vehicle is assigned to the first mission. The second vehicle may be assigned to perform a second mission that is not expected to expose the second vehicle to an ice storm.

By factoring the potential effects of weather events on onboard equipment, the system and method can increase the likelihood that missions are successfully completed on time. Another technical effect of the system and method disclosed herein is a reduction of weather-related physical and operational degradation of onboard equipment (relative to systems that do not factor weather effects on equipment), which may extend the operating life of the equipment and/or improve performance of the equipment.

The system and method disclosed herein are not limited to delegation of missions, and may operate to control the vehicles in real-time as the vehicles travel on the routes. The system and method may alter the performance of a mission mid-trip in response to weather. For example, based on a change in the weather, the system and method may slow, accelerate, or stop the vehicle, change the planned route of the vehicle, modify operation of one or more pieces of onboard equipment, notify an operator, instruct an operator to install auxiliary equipment on the vehicle, or the like. The responsive action that is taken may be selected based on the type and severity of the weather change, as well as a performance relationship between the weather and the onboard equipment of the vehicle.

Embodiments of the systems and methods disclosed do more than automate a process that could be entirely performed by a human. For example, the systems and methods herein are able to receive and analyze large amounts of data in real-time to make informed, repeatable determinations. The data includes weather data, trip schedules, vehicle information, vehicle availability, performance relationships between specific types of equipment and specific weather events, maintenance records of the vehicles, and the like. The operations of the systems are prescribed by programmed instructions, such that the operations are repeatable and reliable. The human would not be able to access, absorb, and make determinations about all of this information in real-time to assign vehicles to missions or modify performance of a mission mid-trip. The system optionally may utilize machine learning and/or neural networks such that the system adapts over time.

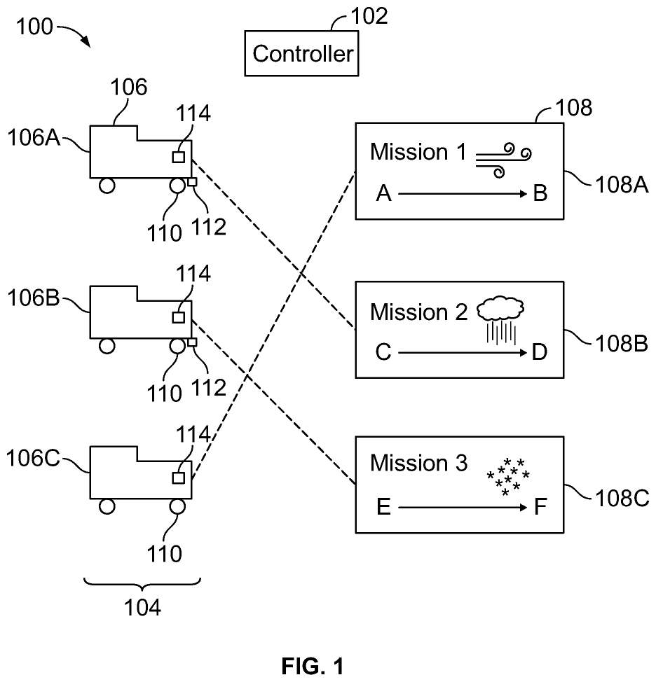

FIG. 1 is a diagram of a vehicle evaluation and control system 100 according to an embodiment. The vehicle evaluation and control system (hereafter system) includes a controller device 102 and a fleet 104 of plural vehicles 106. The controller may be a scheduler that assigns vehicles to perform different missions 108. The missions may be scheduled and/or requested trips. The missions in FIG. 1 include a first mission 108A, a second mission 108B, and a third mission 108C. The first mission is from location A to location B. The second mission is from location C to location D. The third mission is from location E to location F.

The vehicles are propulsion-generating vehicles that have respective propulsion systems to propel movement of the vehicles. The propulsion systems represent equipment and any associated software used to provide work for propelling the vehicle along the route. A suitable propulsion system can include one or more traction motors, inverters, combustion engines, battery systems, and/or the like. The vehicles may include brake systems to slow movement of the vehicles. The brake systems may include air brake systems, friction brake systems, rheostatic or regenerative brake systems (e.g., using motors), and/or the like. In the illustrated embodiment, the propulsion is provided by exerting a torque on wheels 110 of the vehicle to rotate the wheels relative to a route on which the vehicle travels.

The vehicles in FIG. 1 are illustrated as discrete vehicles that are not physically connected to any other vehicles. Optionally, the vehicles in FIG. 1 may be mechanically coupled to other vehicles, such as one or more trailers, rail cars, and the like, to form a vehicle system. Even if not mechanically connected to any other vehicle, one or more of the vehicles may communicate with at least another vehicle to coordinate movements so that the vehicles move together as a vehicle system (e.g., in a convoy). As used, the term convoy here is functionally interchangeable with other like terms, such as consist, swarm, platoon, fleet, train and other vehicle groupings used in various end use applications.

In one embodiment, the vehicles may be rail vehicles that travel on railroad tracks, which represent the routes on which the vehicles travel. The vehicles may be locomotives. Although not shown, the vehicles may be coupled to one or more other rail vehicles, such as non-propulsion-generating rail cars that carry cargo and/or passengers. In another embodiment, one or more of the vehicles may be designed to travel on a road or path. For example, the vehicle may be a truck. Suitable trucks may include a highway capable semi-truck, mining truck, logging truck, or the like. The vehicles in other examples may include one or more other types of vehicles such as automobiles, aircraft, buses, agricultural vehicles, marine vessels, and/or other off-highway vehicles (e.g., vehicles that are not legally permitted and/or are not designed for travel on public roadways).

The controller may be a computer, server, workstation, or the like that is offboard the vehicles. The controller may be located at a dispatch facility or at a data storage center. The controller includes one or more processors. The controller includes and/or is connected with a tangible and non-transitory computer-readable storage medium (e.g., memory). The memory may store program instructions (e.g., software) that is executable by the controller to perform functions of the controller described herein. The functions may include assigning vehicles to complete the missions and/or controlling the vehicles during the assigned missions based in part on predicted weather events, which includes weather and weather-related conditions predicted to be experienced by the respective vehicle that performs and completes a corresponding trip. In an alternative embodiment, the controller may be disposed onboard one of the vehicles.

The controller considers the potential effects of weather on the ability of the vehicles to complete the missions on time. For example, the vehicles in the fleet have different likelihoods of successfully completing the missions. This variance may be based, at least in part, on differences in onboard equipment of the vehicles. Two different types or conditions of onboard equipment may be differently impacted by weather experienced during the missions. One vehicle may have a greater likelihood of success when traveling through a certain type of weather event than a second vehicle based on differences in onboard equipment. The likelihood of success of a vehicle when exposed to a certain type of weather is referred to herein as weather fitness. The weather fitness indicates a predicted ability of the vehicle to avoid an equipment failure and/or a delay when performing a mission that exposed the vehicle to the weather event. A greater weather fitness indicates that the vehicle is less impacted by a predicted weather event on the route than another vehicle that has a reduced weather fitness with respect to the same trip.

For example, a vehicle that has an active traction enhancing device to increase friction on the route may have a greater weather fitness in rain, snow, ice, and debris accumulation (e.g., leaves) on the route than another vehicle that lacks the active traction enhancing device. The active traction enhancing device may enhance friction by removing friction-reducing substances and/or objects from the route and/or applying friction-increasing substances to the route. Suitable active traction enhancing devices may include a rail cleaner nozzle, a snow blower, and a sand emitter.

One vehicle may have different weather fitness characterizations with respect to different weather events based on the onboard equipment of the vehicle. For example, the vehicle may have a relatively low weather fitness with respect to a first weather event because a first piece of equipment onboard the vehicle is negatively impacted by the first weather event and/or the vehicle lacks a piece of equipment that reduces the impact of the first weather event. For example, the vehicle may lack an active traction enhancing device that would reduce the impact of rain, ice, snow, and debris accumulation on the route. Furthermore, the same vehicle may have a relatively high weather fitness with respect to a second weather event because the second weather event has limited or no negative impact on the equipment and/or performance of the vehicle. The impact of the second weather event may be beneficially limited due to the type and/or condition of a first piece of equipment onboard the vehicle and/or the presence of a piece of equipment that reduces the impact of the second weather event.

The controller according to an embodiment evaluates the missions and the vehicles to assign the vehicles to the missions in a way that increases the overall success rate of the missions being completed on time, relative to assigning the vehicles to the missions without considering weather-based impacts on the vehicles. Each mission may represent a transport of cargo and/or passengers from a first designated location to a section designated location.

The controller may obtain trip parameters about each of the trips (e.g., missions). The trip parameters may include the designated departure and arrival locations, a time at which the vehicle is to arrive at the arrival location, a time at which the vehicle is to leave the departure location, a path or series of route segments to travel from the departure location to the arrival location, condition of those route segments, number of vehicles required per mission, compatibility of vehicles in a consist, and/or the like. The trip parameters may be accessed from a database that collects and stores requested trips. Alternatively, the trip parameters may be received in a message communicated by a communication device.

The controller then obtains or receives one or more predicted weather events that may be experienced by a vehicle that performs each respective mission. For example, based on the trip parameters, the controller estimates the progression of the vehicle during each mission over time. The progression refers to the location of the vehicle over time during the performance of the mission. For example, with respect to the first mission in FIG. 1, the controller may estimate the location of the vehicle performing the first mission over time based on a time at which the vehicle is scheduled to depart from Location A, a path of travel of the vehicle, and a predicted travel speed for the vehicle. The controller then determines at least one predicted weather event that is expected along the route during the mission. The predicted weather event may be based on a comparison between weather data and the estimated progression of the vehicle along the route during the trip. The weather data may include forecasted weather, historical weather patterns, real-time weather sensor data, and/or the like. Relevant weather data is data that geographically and temporally (e.g., in time) overlaps with the estimated progression of the vehicle during the mission. A weather event may be determined when the relevant weather data is indicative of one or more designated categories. Suitable categories of weather that can be classified as weather events by the controller can include high temperature, low temperature, rain, snow, ice (e.g., sleet, hail, etc.), high humidity, low humidity, flooding, dusty condition (e.g., dust storm), debris accumulation on the route, high wind, and/or the like.

The weather events may be determined based on respective threshold values. For example, with regard to ambient temperature (as a weather event) a high temperature event may be determined based on a measurement of ambient temperature that is above a determined high temperature threshold or above a determined temperature range. Similarly, a low temperature weather event may be based on a measured ambient temperature being lower than a designated low temperature threshold or below a determined temperature range. Humidity events may be determined based at least in part on high and low threshold values. Precipitation-based events (e.g., rain, snow, ice) may be based on recording at least a designated amount or rate of precipitation.

Some weather events may be determined based at least in part on observations from other vehicles. For example, flooding and debris accumulation may be determined based on communications from vehicles ahead that observe the flooding and/or debris on the route. Flooding can affect the route. Standing water may cover at least a portion of a route, and that water may have a depth value associated therewith. In one embodiment, flooding may be measured indirectly, such as by the flood water washing away ballast underneath the rails of a track. Thus, the water from a flood may be determined directly as the presence of water, or may be determined indirectly as the effect(s) of flood water, or both.

In an example, if the weather data forecasts wind speeds at a certain geographic location that are above a designated threshold speed during a period of time that the vehicle performing the mission is expected to be traveling through that geographic location, then the controller determines that the mission has a high wind weather event. Some missions may extend for hundreds of miles. The controller may determine multiple different weather events for the same mission based on the weather data. Some of the weather events may overlap at least partially, such that the vehicle is exposed to two or more types of inclement weather conditions during a common time period.

In FIG. 1, the first mission has a symbol indicating high wind. In FIG. 1, the controller determines that rain is expected to be experienced by the vehicle that performs the second mission. The controller determines that snow, ice, and/or cold temperatures are the weather events associated with the third mission.

For each mission, the controller may characterize the weather fitness of one or more vehicles for traveling on the route during that mission. The controller then uses the weather fitness as a factor for selecting the vehicle that is to complete the mission. The weather fitness characterization is based at least in part on the weather event(s) expected and equipment characteristics of equipment disposed onboard the respective vehicle. The equipment characteristics may include the type of equipment onboard the vehicle as well as the condition of the equipment. For example, age and health of a piece of equipment may represent the condition of the piece of equipment. The health may refer to the state of physical components, such as whether the components are damaged, dirty, degraded, malfunctioning, and the like.

The controller may obtain maintenance records and open maintenance tickets relating to the onboard equipment of a vehicle to characterize the health of the onboard equipment. For example, if the maintenance records indicate that a piece of equipment was recently replaced or fixed, then the health of that piece of equipment is determined to be good. Equipment that is newer and/or in better health may be less impacted by inclement weather than equipment that is older and/or in worse health. Open maintenance tickets refer to scheduled maintenance that is yet to be completed. An open maintenance ticket for a specific piece of equipment onboard a vehicle may indicate that the piece of equipment experienced a fault or failure and/or is degraded to the point of requiring maintenance to fix or replace a component. The presence of an open maintenance ticket may indicate that the piece of equipment is in poor health.

In FIG. 1, the three vehicles have different types of onboard equipment. For example, the first and second vehicles 106A, 106B have an active traction enhancing device 112, and the third vehicle 106C lacks an active traction enhancing device. The types of equipment may encompass specific model types, manufacturers, and the like. In FIG. 1, the first and second vehicles both have air compressors 114, but the air compressors differ in type and/or condition. For example, the air compressor of the first vehicle may have a different manufacturer, working element, size, load/power requirement, model type, age, and/or health than the air compressor of the second vehicle. The working element of the compressor on the first vehicle may be oil, whereas the compressor on the second vehicle is oil-free. The third vehicle includes an air compressor which may have the same or different equipment characteristics as the air compressors onboard the first and second vehicles.

The controller may characterize the weather fitness of a respective vehicle based at least in part on a performance relationship between the weather event (or events) expected during the mission and the type of equipment onboard the vehicle. The performance relationship is a correlation or association between a type of weather event and a type of equipment. Some performance relationships indicate that a particular type of equipment is negatively impacted by the weather event. The negative impact means that the weather event may disrupt the operation of the piece of equipment, reduce the performance capability of the piece of equipment, degrade or damage the piece of equipment, or at least present an elevated risk of damage to the piece of equipment. For example, a battery pack in a vehicle may be negatively affected by extreme temperatures. These extremes may be one or both of high and low extremes. In another example, vehicles that are not equipped with active traction enhancing devices (e.g., rail cleaners, blowers, sand emitters, etc.) would suffer in rain, snow, ice, and debris accumulation (e.g., leaves and the like) that reduce the friction between the wheels of the vehicle and the route. Furthermore, vehicles that have direct current (DC) motors may be more negatively impacted in rain and low humidity environments. In rain and low humidity, DC motors can experience grounding and flashover, which is arcing between brushes of the motor. For example, in lower humidity conditions, carbon dust from brushes of the DC motors may be more likely to provide a conductive path that causes arcing and/or flashover than in higher humidity conditions.

The performance relationships between specific types of onboard equipment and weather events may be determined based on historical data, observations in the field, and/or experimental data. For example, historical data in a database may provide information about delays and equipment failures experienced by vehicles in the past that have certain types of equipment. The historical data may indicate a number of failures and/or delays documented, and may provide information about a severity of the failures and/or delays. The historical information may include a record of maintenance events to fix or replace a specific piece of equipment. The observations in the field can include observations made by an operator as the vehicle is traveling through a certain weather event. The observations may be based on sensor data. For example, an operator may observe that electrical short circuits occur more often in rainy and/or wet environments than dry environments, and occur more often when the vehicle has DC motors than AC motors. Such information can be used to formulate the performance relationship between type of equipment and type of weather event. The performance relationship may be used to determine the weather fitness of a vehicle with a specific type of equipment to travel through a certain weather event.

The controller may characterize the weather fitness of a vehicle for traveling through a specific weather event based on any documented performance relationships between that weather event and associated types of equipment that are onboard the vehicle. In addition to the performance relationship, the controller may factor conditions of the onboard equipment, such as the age and health. For example, the controller may adjust the weather fitness higher (e.g., greater fitness) if one or more pieces of equipment that affect, or are effected by the weather event, are relatively new and/or in good health. Conversely, the controller may reduce the weather fitness if the one or more pieces of equipment impacted by the weather event are relatively old and/or in poor health.

Referring to FIG. 1, the controller may characterize the weather fitness of at least some of the vehicles in the fleet for traveling through high winds on the first mission. The controller may analyze equipment characteristics that are relevant to wind, such as the height, weight, and center of gravity of the vehicles as well as any other vehicles that may be propelled by the vehicles. Taller, lighter vehicles with higher centers of gravity may be more impacted by high winds than shorter, heavier vehicles with lower centers of gravity. As such, the shorter, heavier, and/or lower-centered vehicles have a greater weather fitness with respect to high winds than taller, lighter, and/or higher-centered vehicles.

The controller may characterize the weather fitness of at least some of the vehicles in the fleet for traveling through rain on the second mission. The controller may characterize the weather fitness of at least some of the vehicles in the fleet for traveling through cold temperatures, snow, and/or ice on the third mission. In the illustrated embodiment, the first and second vehicles may have a greater weather fitness for performing the second and third missions than the third vehicle because of the active friction enhancing devices onboard the first and second vehicles. The third vehicle that lacks an active friction enhancing device may have a greater risk of delay and/or equipment failure when exposed to the rain, snow, and ice than the first and second vehicles. As such, the controller may classify or rank the first and second vehicles as having a greater weather fitness than the third vehicle with respect to performing the second and third missions.

The controller assigns the vehicles based at least in part on the weather fitness of the vehicles to the expected weather events. For example, the controller delegates the missions to the vehicles in an attempt to assign a vehicle with relatively high or maximum weather fitness to each mission. By assigning the vehicles based at least in part on weather fitness, the controller attempts to increase overall network success and throughput by reducing the likelihood of weather-attributable delays and failures during the missions. In general, if two or more vehicles are available and capable of performing a given mission, the controller compares the weather fitness of each of the vehicles with respect to that mission. The controller may assign the mission to the vehicle that has the greatest weather fitness (or a top level of weather fitness) for that particular mission, notwithstanding other considerations such as vehicle availability and mission priority. For example, the second and third missions in FIG. 1 are assigned to the first and second vehicles, which have greater weather fitness for performing the second and third missions than the third vehicle.

In an embodiment, the controller may characterize the weather fitness of a single vehicle for multiple different potential missions. The missions may be exclusive such that the vehicle can practically only perform one of the missions due to time and/or geographic constraints. The controller may assign the vehicle to perform one of the missions based at least in part on the weather fitness of the vehicle for each of the potential missions. In general and notwithstanding other considerations, if the vehicle has a greater weather fitness for a first mission than a second mission based on the anticipated weather events and the onboard equipment, then the controller assigns the vehicle to the first mission (not the second mission).

In the embodiment of FIG. 1, the controller may determine the weather fitness of each of the three vehicles for each of the three missions, yielding nine discrete weather fitness characterizations. Assuming that each of the vehicles is assigned to perform a different one of the three missions, there are six possible assignment configurations. One assignment configuration is that the first vehicle performs the first mission, the second vehicle performs the second mission, and the third vehicle performs the third mission. In an embodiment, notwithstanding other considerations, the controller may determine which of the possible assignment configurations yields the greatest total weather fitness. If the weather fitness characterizations are represented as numerical values on a scale, with the values proportional to weather fitness, then the controller calculates which assignment configuration yields the greatest combined value. The controller selects that assignment configuration, and therefore assigns the vehicles according to that configuration.

In FIG. 1, the first vehicle is assigned to complete the second mission that has the rain weather event. The first vehicle has the active traction enhancing device, such as a sand emitter or a rail cleaner nozzle, to combat the reduced friction with the route caused by the rain. The second vehicle is assigned to complete the third mission that has the cold temperature and snow and/or ice. The second vehicle may have an active traction enhancing device to increase the friction with the route. The active traction enhancing device on the second vehicle may be a snow blower, for example, to blow snow away from the wheel-route interface. Between the first and second vehicle, the second vehicle may have a greater weather fitness than the first vehicle for traveling through the cold and snow and ice. For example, the air compressor of the second vehicle may be less impacted by the cold than the air compressor of the first vehicle. This deviation between the air compressors may be attributable to different types of air compressors (e.g., oil or oil-free, different manufacturer, different model, etc.) and/or different conditions of the air compressors (e.g., different ages, different levels of degradation and damage, an open maintenance ticket for the air compressor of the first vehicle, etc.).

The third vehicle is assigned to complete the first mission which is expected to feature high winds. The third vehicle may have a greater weather fitness for performing the first mission than the second and third vehicles. For example, the third vehicle may have a lower center of gravity than the first and second vehicles. The lower center of gravity may be attributable to a shorter height, a lower weight distribution, shorter stacking of cargo containers, and/or the like. Optionally, even if the third vehicle has a similar weather fitness with respect to high winds than the other two vehicles, the third vehicle may be assigned to complete the first mission if that assignment configuration yields the greatest combined fitness relative to other possible assignment configurations. For example, the third vehicle may be assigned to the first mission because the first mission is not expected to feature precipitation unlike the other two missions, considering that the third vehicle lacks a friction enhancing device.

Although only three vehicles and three missions are shown in FIG. 1, the controller may be utilized to delegate dozens or even hundreds of overlapping missions to a fleet of dozens or even hundreds of vehicles. As such, the controller may determine hundreds or even thousands of weather fitness characterizations. The controller may analyze those characterizations and generates an assignment configuration in an attempt to assign a vehicle with a high weather fitness to each of the missions. The controller generates the assignment configuration to increase overall network success and throughput by reducing the likelihood of weather-attributable delays and failures during the missions.

In addition to considering weather-based effects, the controller may assign the missions to the vehicles based at least in part on vehicle availability, vehicle capability, and/or mission priority. Vehicle availability refers to whether a given vehicle in the fleet is available to complete the given mission. For example, a vehicle is available to complete the first mission in FIG. 1 if the vehicle is able to be at Location A (at the start of the trip) before a scheduled start of the mission and is available during an entire scheduled time period of the mission from the start to the end, when the vehicle reaches Location B. For example, if the vehicle is already booked to perform another trip that overlaps the scheduled time period of the first mission, the vehicle is not available to complete the first trip (unless the vehicle drops the other trip). The capability of a vehicle refers to the ability of the vehicle to satisfy trip parameters of the trip. The trip parameters may include hauling a specific amount and/or weight of cargo, traveling at least a given average speed during the trip, achieving at least a threshold fuel efficiency, and/or arriving at the destination location by a designated arrival time. The capability of a vehicle to perform a given mission is affected by the propulsion system and brake system of the vehicle. Some vehicles may lack the power, torque, efficiency, and/or the like necessary to satisfy the trip parameters.

The availability and the capability may be treated as constraints in the weather-based evaluation system. For example, if the controller determines that the first vehicle is not available or capable of performing the first mission, then the controller may exclude the first vehicle from being assigned to the first mission. During the analysis, the controller would not even characterize the weather fitness of the first vehicle for performing the first mission. For example, the controller would only characterize the weather fitness of the first vehicle with respect to the second and third missions.

The mission priority refers to a priority or ranking of one or more missions relative to other missions. Some missions may be prioritized over other missions due to a perceived greater importance and/or greater urgency. For example, rush shipment of goods may be prioritized over a non-rush shipment. The controller may factor the mission priority when assigning the vehicles to perform and complete the missions. In an embodiment, the controller may assign high weather fitness vehicles to the priority missions, and assigns any remaining high weather fitness vehicles to non-priority missions. For example, if there are ten missions that are expected to feature rain, and five of those ten missions are priority, the controller assigns vehicles that have high (e.g., the highest) weather fitness in rain to the five priority missions. The selected vehicles provide a greater likelihood of successfully completing the priority missions, relative to assigning vehicles with lower fitness in rain to perform one or more of the priority missions. If there are more than five vehicles with high-fitness in rain, then the controller may assign at least some of those vehicles to the five non-priority missions, notwithstanding other considerations. The controller may be programmed to compromise on the vehicles that perform non-priority missions before compromising on the vehicles that perform priority missions.

In an embodiment, after assigning the vehicles to the missions, the controller may generate a transportation network schedule that includes the vehicle-mission assignments. The controller may communicate the transportation network schedule to the vehicles that are assigned to the missions, to one or more stations, to a remote computing and data storage center, to a dispatch facility, and/or the like. The transportation network schedule may include scheduling information as well as the assignments. The scheduling information may include the departure and arrival locations and planned times for each of the missions. The scheduling information may include scheduled paths (e.g., segments of routes, turns, and other navigational aspects) for the missions.

In addition to scheduling, the controller may monitor the progression of the missions by the assigned vehicles and may update the missions mid-trip when appropriate. A mission may be updated mid-trip based on a change in weather, as described herein.

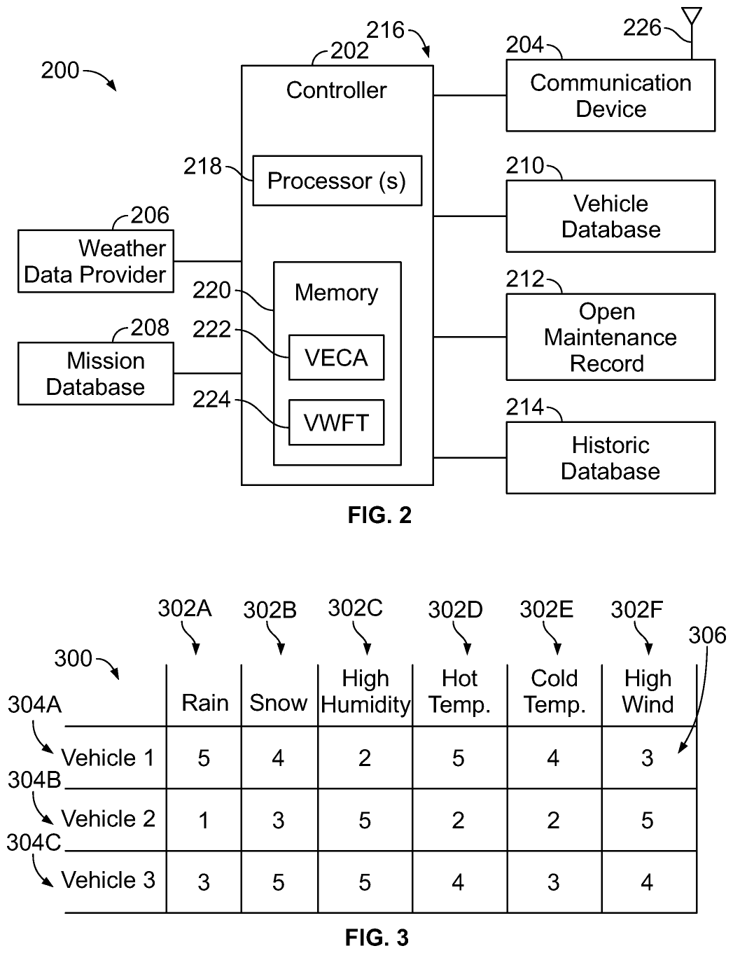

FIG. 2 is a schematic illustration of a vehicle evaluation and control system 200 according to an embodiment. The vehicle evaluation and control system includes a controller 202, a communication device 204, a weather data provider 206, a mission database 208, a vehicle database 210, an open maintenance record 212, and a historical database 214. At least some of the components of the vehicle evaluation and control system may be integrated into a common control device 216. For example, the controller and the communication device may be components of the control device. The controller and the communication device may be disposed within a housing or case of the control device. The control device may be a computer, server, smartphone, or the like. The control device may be the controller device shown in FIG. 1.

The controller is operably connected to the other components of the system via wired (e.g., electrically conductive elements) and/or wireless communication pathways. In an embodiment, the controller wirelessly communicates with one or more of the components of the system via the communication device, which is wired to the controller. For example, the communication device may bidirectionally communicate with the weather data provider.

The communication device represents hardware circuitry that can wirelessly communicate electrical signals. For example, the communication device can represent transceiving circuitry, one or more antennas 226, and the like. The transceiving circuitry may include a transceiver or a separate transmitter and receiver. The electrical signals can form data packets that in the aggregate represent messages. The communication device optionally may be a radio that wirelessly communicates the electrical signals as radio frequency (RF) signals. The communication device can transmit or broadcast messages that are generated by the controller. The communication device may receive messages and forward content of the messages to the controller for analysis of the received message content.

The controller represents hardware circuitry that includes and/or is connected with one or more processors 218 (e.g., one or more microprocessors, integrated circuits, microcontrollers, field programmable gate arrays, etc.). The controller includes and/or is connected with a tangible and non-transitory computer-readable storage medium (e.g., memory) 220. The memory may be disposed within the housing of the control device. The memory may store programmed instructions (e.g., software) that is executed by the one or more processors to perform the operations of the controller described herein. For example, some of the programmed instructions represent a vehicle evaluation and control (VEC) algorithm 222 (e.g., VECA in FIG. 2) that is stored in the memory. The VEC algorithm may be a program (e.g., application) that is installed in the memory to enable the controller to perform the weather-based vehicle mission assignments described with reference to FIG. 1.

The memory may store vehicle weather fitness (VWF) data. The VWF data may be indicative of a plurality of fitness indicia for each of multiple vehicle associated with different corresponding types of weather events. Stated differently, the VWF data may provide weather fitness characterizations for multiple vehicles with respect to exposure to different weather events. The VWF data may be generated by the one or more processors of the controller. For example, the one or more processors may characterize the fitness of each vehicle in one or more different weather events based on equipment characteristics of the equipment onboard the vehicle. Alternatively, the VWF data may be generated by one or more other processors and communicated to the control device to be stored in the memory.

The VWF data optionally may be organized into a graphical tool, such as a VWF table 224 (e.g., VWFT in FIG. 2). The VWF table may include a first set of fitness indicia for a first vehicle. Each fitness indicia in the first set is associated with a different type of weather event. The VWF table may include additional sets of fitness indicia corresponding to other vehicles in a fleet, where each set has at least one fitness indicia that associates the respective vehicle with a particular weather event. The fitness indicia may indicate a rating on a scale that is used to compare and rank the weather fitness of the vehicles. The rating may be a quantifiable value. The quantifiable value may be a value on a numerical scale. An example is 8 out of 10, where 10 represents the greatest level of weather fitness and 1 represents the least level of fitness. The rating may be a level or tier. A simple example is three levels with one level representing good weather fitness, a second level representing medium or intermediate fitness, and the third level representing poor fitness. The fitness indicia may be presented as a numerical value (e.g., 8 out of 10), a symbol (e.g., thumb up, thumb down, etc.), a color (e.g., green, yellow, red, etc.), a word or phrase (e.g., good fitness, intermediate fitness, poor fitness, etc.), or the like. The scale used may have any number of discrete levels for rating the weather fitness of the vehicles to the different weather events.

The mission database includes information and parameters related to trips to be performed by vehicles in the fleet. The mission information and parameters for a given mission can include departure location, departure time, arrival location, arrival time, path from the departure location to the arrival location, cargo and/or passenger information, movement parameters, and/or the like. The movement parameters may include speed thresholds and limits, power output thresholds and limits, noise limits, and/or the like. The mission database may indicate mission priorities, such as whether any of the missions are higher priority than other missions.

The controller is operably connected to the weather data provider to receive weather data that is relevant to one or more missions. The weather data provider may be an application programming interface (API) that enables the controller to communicate with a weather service that monitors and forecasts weather conditions. In an embodiment, the controller may communicate a timestamp and geographic area to the weather data provider. The timestamp and geographic area indicate a time or time period in which a vehicle performing one of the missions, of the mission database, is expected to be traversing through the geographic area. The controller determines one or more timestamps and geographic areas for each mission based on the mission information and parameters in the mission database. In response to receiving the timestamp and geographic area, the weather data provider may send weather data that corresponds to the time and location identified in the timestamp and geographic area, respectively. The controller may store the weather data received from the weather data provider in the memory. The weather data is used when implementing the VEC algorithm to predict whether a vehicle performing a mission will experience any inclement weather that could impact the likelihood of success of the trip.

The vehicle database identifies vehicles and provides equipment characteristics of equipment onboard the vehicles. For example, the vehicle database may have information about every vehicle in a fleet. The information may include equipment characteristics such as type of equipment onboard, age of equipment, health of equipment, and the like. The type of equipment may include general type (e.g., working elements, such as gasoline engine or diesel engine, oil or oil-free air compressor, etc.), manufacturer, model number, and the like. The onboard equipment in the database may include motors, wheels, air compressors, radiators (and radiator fans), brakes, at least one battery, a plow, an active traction enhancing device, an engine, an inverter assembly, fuel cell, or the like. The onboard equipment may encompass software that controls operation of one or more pieces of equipment. Software-based equipment may include electronic traction control systems. An example traction control system controls torque applied to the wheels of the vehicle for the purpose of enabling the wheels to operate to a maximum available adhesion, with a minimal level of slip, relative to controlling the wheels according to conventional control operations. The vehicle database may include details about vehicle capability, such as towing/hauling capacity, power output (e.g., horsepower), torque, fuel efficiency, and/or the like.

The open maintenance record identifies vehicles and equipment onboard those vehicles with unresolved maintenance issues. For example, if a vehicle controller onboard a vehicle detects a fault or damage to a piece of equipment, the vehicle controller may notify an offboard device to schedule maintenance for that piece of equipment. The offboard device opens a maintenance ticket. The vehicle optionally may continue to operate while the maintenance ticket is open before the issue can be addressed, depending on the severity of the fault or damage and/or the necessity of the piece of equipment. For example, if the equipment is not necessary, the vehicle may continue to operate without using the equipment until maintenance can be performed on the equipment. The controller that performs the evaluation and control algorithm disclosed herein may interpret equipment with an open ticket in the maintenance record as having degraded health. If the equipment with degraded health is predicted to be impacted by a weather event (according to a performance relationship), then the controller may downgrade the weather fitness of that vehicle for traveling through the particular weather event (relative to the weather fitness based on the same equipment in better health).

The historical database may include information about closed maintenance events, historical performance data, and historical weather data. The closed maintenance events refer to a history of maintenance performed on the onboard equipment of the vehicle fleet. The closed maintenance events may indicate when a particular piece of equipment is replaced, fixed, and/or serviced. A recent closed maintenance event pertaining to a piece of equipment may indicate that the equipment is in good condition. If the piece of equipment is predicted to be impacted by a weather event, the controller may upgrade the weather fitness of that vehicle for traveling through the particular weather event based on a closed maintenance event that indicates the equipment is in good condition.

The historical performance data in the database may refer to past experiences of the vehicles in the fleet and/or other vehicles outside of the fleet. For example, historical performance data may include information about past events in which vehicles having a particular type of equipment experienced equipment failure when exposed to a specific weather event. The weather event may be determined based on correlating the historical weather data to the geographic location and time of the equipment failure. The information about the past events can be analyzed and aggregated to make predictions about the likelihood of similar events occurring in the future. For example, based on the number of times that the equipment failed over a designated period of time and/or relative to the number of total trips in which similar equipment was exposed to the weather event and did not fail, the controller can estimate a likelihood of equipment failure between that type of equipment and the weather event. This likelihood of equipment failure may be used to generate a performance relationship between the type of equipment and the weather event.

Furthermore, the historical performance data can be analyzed to determine a severity of each of the documented equipment failures. The severity may refer to the extent of damage to the equipment caused by the weather and/or the amount of disruption to the mission caused by the weather-impacted equipment. The controller may use the severity of the past equipment failures, with the likelihood of failure, to determine the performance relationship between the type of equipment and the weather event. For example, if exposure to a certain inclement weather would pose a high risk of equipment failure and/or the potential equipment failure would be severe, then the controller may downgrade the weather fitness of a vehicle having that equipment more so than if the risk of failure is less and/or the failure is expected to be less severe.

Optionally, one or more of the vehicle database, the open maintenance record, the mission database, and the historical database may be stored in the memory of the controller.

In an embodiment, the controller may aggregate information from various sources, such as the weather data provider, the mission database, the vehicle database, the open maintenance record, and the historical database. The controller may process the information, according to program instructions of the VEC algorithm, to characterize the weather fitness of one or more vehicles for performing different scheduled missions.

In an embodiment, the controller may generate and/or update the VWF table. The VWF table may be generated and/or updated based on the information from the vehicle database, the historical database, and the open maintenance record.

FIG. 3 depicts a vehicle weather fitness (VWF) table 300 according to an embodiment. The VWF table may represent the VWF table in FIG. 2. The VWF table includes multiple columns 302 representing different weather events and multiple rows 304 representing different specific vehicles. The weather event in a first column 302A is rain. Snow is in a second column 302B. The third column 302C is high humidity, then hot and cold temperatures in the fourth and fifth columns 302D, 302E, respectively. The sixth column 302F is high wind. The first, second, and third rows 304A, 304B, 304C represent first, second, and third vehicles, respectively. The VWF table may include additional and/or different weather events in other embodiments, such as ice, flooding, debris accumulation, low humidity, particular storms, and/or the like. The VWF table optionally may include more or less than three vehicles. For example, the VWF table may have a row for every vehicle in a fleet.

The VWF table is populated with fitness indicia 306. Each fitness indicia represents a fitness characterization for a particular vehicle with respect to a particular weather event. The fitness indicia provides a rating or indicator of how significantly the vehicle is expected to be impacted by the weather event if exposed to that weather event during a mission. The fitness indicia indicate ratings that enable comparisons between vehicles and weather events. In the illustrated embodiment, the fitness indica in the table are numerical values within a scale from 1 to 5, where 5 represents the best fitness and 1 represents the worst fitness. In other embodiments, the fitness indicia may be numerical values on a different scale (e.g., 1-10, 1-100, etc.), colors, symbols, words, and/or the like.

The controller of FIG. 2 may generate the VWF table based on information received from the vehicle database, the historical database, and the open maintenance record. For example, the vehicle database provides information about the equipment onboard each of the vehicles in the table. The historical database and the open maintenance record provides information about past events used to determine how the onboard equipment is impacted, if at all, when exposed to the listed weather events. For example, the controller may formulate and/or adjust performance relationships between types of equipment and weather events based on the historical database. Some example performance relationships are described below.

Certain types of air compressors are more negatively impacted in cold weather than other types of air compressors. Although cold air is generally more difficult to compress than warm air, certain air compressors may be more likely to experience clogged filters and/or damage due to cold temperatures than other air compressors. In FIG. 3, the second vehicle has a weather fitness indicia of “2” in cold temperature, which is relatively poor. The other two vehicles have higher fitness indicia in the cold. The second vehicle may have an air compressor that is more impacted by cold (e.g., has a greater risk of equipment failure) than the air compressors on the first and third vehicles. Also, the conditions of the air compressors may affect the different fitness indicia. For example, the air compressor of the first vehicle may be in better condition than the air compressor of the third vehicle due to a younger service age, a recent maintenance event, or the like.

Radiator fans are another piece of onboard equipment that may be impacted by cold and ice. For example, a fan may freeze in the cold, which disrupts the ability of the fan to operate. Ice on the frame or grill of the radiator fan may block or at least limit air paths into and/or from the radiator, which degrades the operational capability of the radiator fan. Furthermore, ice on the blades may upset the balance of the fan, which can damage the radiator fan. Certain types and conditions of radiator fans may be better able to withstand the cold and ice than other types and conditions of radiator fans.

Another performance relationship is between electrical storage devices, such as batteries and battery packs, and temperature. Battery performance may suffer in extreme temperatures, both hot and cold. Vehicles that include large battery packs, such as hybrid and all-electric vehicles, may be more likely to experience performance degradation and/or failure in hot and cold temperatures than vehicles with fewer and/or smaller batteries. As another example, vehicles may include equipment to change the temperature of onboard batteries. These vehicles may include heaters and/or coolers that heat or cool the batteries. These vehicles may be capable of traveling through colder or warmer areas than vehicles that do not have these types of heating and/or cooling equipment. As a result, these vehicles may be able to heat or cool the batteries, and prevent the batteries from operating in undesirable ways (e.g., decreased charging capacities, decreased charging rates, decreased discharge rates, etc.) while vehicles not having this equipment may be unable to prevent the batteries from operating in undesirable ways during travel in cold or warm climates.

When multiple pieces of equipment onboard a vehicle are impacted by a common weather event, the fitness indicia for that vehicle in the VWF table may be a function of the individual fitness characteristics of each of the pieces of equipment. Thus, the “3” for the third vehicle may be based on an analysis of all pieces of equipment onboard the third vehicle that may be negatively affected by the cold.

Another performance relationship example is motors in extreme or abnormal humidity conditions. Extreme humidity may include a relative humidity that is outside of a typical humidity range. A humidity that is above the upper limit of the typical humidity range or below the lower limit of the typical humidity range may be considered as an extreme or abnormal humidity. For example, the typical humidity range may be between 30% and 60% relative humidity outside. Other ranges may be used to define the typical or normal humidity range in other embodiments, such as 30% to 50%, 25% to 55%, and the like. DC-type motors may by more impacted by extreme (e.g., high and low) humidity environments than AC-type motors, such that DC motors are less reliable than AC motors in extreme humidity. For example, DC motors may risk flashover and/or ground faults in high humidity due to a reduction in breakdown voltage. The reduced breakdown voltage can enable arcing between brushes. Furthermore, DC motors may risk flashover and grounding in low humidity conditions as a result of increased carbon dust from wearing brushes. The AC-type motors are not as impacted by humidity extremes as DC-type motors. In FIG. 3, the first vehicle has a fitness indicia of “2” and the other two vehicles have fitness indicia of “5” in high humidity. The low rating for the first vehicle may be attributable to the first vehicle including one or more DC motors. The second and third vehicles may have greater fitness in extreme humidity environments due to the presence of AC motors and the lack of DC motors.

Equipment such as plows and active traction enhancing devices are beneficial to have when traveling through weather events that affect friction between the vehicle and the route, such as rain, snow, ice, and debris on the route. For example, a vehicle with a snow plow would have good weather fitness for traveling through snow and snow drifts. The placement of the vehicles in a consist may be a factor in the controller determinations, particularly in this example. The vehicle with a traction-enhancing device should be placed at the front of the consist. Onboard equipment is not limited to equipment that is installed in the operational condition. For example, the third vehicle may have a plow onboard in storage, yet the third vehicle is able to install and use the plow so the third vehicle receives a fitness indicia of “5” for snow. Auxiliary equipment refers to equipment that may be onboard a vehicle without being installed at all times.

Active traction enhancing devices can include sand emitters, rail cleaner nozzles, blowers, and/or the like. In FIG. 3, the first vehicle may include at least one active traction enhancing device, so the first vehicle has good fitness in the rain and snow categories. The second vehicle may lack an active traction enhancing device, so the second vehicle has relatively poor fitness in the rain and snow categories.

Equipment such as active adaptive suspensions are beneficial when traveling through flooded areas of a route. For example, if a segment of the route is flooded, the vehicle with active adaptive suspension could raise the suspension to achieve greater ground clearance.

In high winds, tall, lightweight vehicles with high centers of gravity may risk damage or even being blown over during transit. In FIG. 3, the second vehicle has a greater fitness in the wind than the first and second vehicles. The variance may be attributable to the second vehicle having a lower center of gravity, a shorter height, a greater weight, a different shape that is less impacted by the wind, a different stacking configuration or arrangement of cargo, or the like, relative to the other vehicles.

Another performance relationship may exist between particular storms and air intake systems of vehicles. For example, some air intake systems may be better able to operate in sand storms and/or dust storms than other air intake systems. Intake systems that have filters that may be damaged or plugged up by the sand and/or dust, as well as filters that fail to block the sand and/or dust from entering the engine, have reduced fitness relative to intake systems with better, more resilient filters.

The controller may adjust the fitness indicia in the VWF table by upgrading or downgrading a respective indicia in response to certain events. For example, the controller may upgrade a fitness indicia by increasing the rating in response to a maintenance event that is performed on a corresponding piece of equipment associated with the fitness indicia. Performing maintenance on a piece of equipment may improve the condition of the equipment, rendering the equipment more likely to withstand exposure to a certain type of weather event without damage or failure. Conversely, the controller may downgrade a fitness indicia in the table, by reducing the rating, in response to determining that there is an open maintenance ticket for a corresponding piece of equipment associated with the fitness indicia. The open maintenance ticket indicates that the piece of equipment may have a fault or damage, and would be less likely to withstand exposure to a certain weather event without damage or failure.

In an embodiment, the controller of FIG. 1 and/or FIG. 2 may utilize the VWF table when assigning vehicles to perform missions. For example, if all three of the vehicles in FIG. 3 are available and capable for performing a priority mission that is expected to involve traveling through rain, the first vehicle would be selected to complete the priority mission because the first vehicle has a greater weather fitness in rain than the other two vehicles. In an embodiment, when assigning a plurality of missions to vehicles in a fleet, the controller may perform a solver-type function using the fitness indicia values in the VWF table to solve for a best-case assignment configuration. The best-case assignment configuration in this example would be a configuration that maximizes a combined score or total of the indicia values. For example, if there are ten missions, and “5” represents the greatest weather fitness indicia value for each mission, then the maximum combined score would be 50 (e.g., 5 times 10). The controller attempts to select an assignment configuration, without violating availability, capability, or priority constraints, that achieves a total combined fitness score that is 50. If no possible assignment configurations yield the desired score, then the controller may select a configuration that yields the greatest total combined fitness score (e.g., 49, 48, or the like).

Some missions may utilize multiple propulsion-generating vehicles that define portions of a common vehicle system. For example, a rail-based train may include multiple locomotives that represent a consist. When assigning the vehicles to missions that can use multiple vehicles, the controller may select the vehicles and may select the order based on the performance relationships. For example, if a vehicle system is expected to experience snow when performing a given mission, then the controller may select a vehicle that includes a snow plow, and may arrange the vehicles such that the vehicle with the snow plow is the first or leading vehicle of the vehicle system based on a direction of travel. The controller may select at least a second vehicle for the same mission, to be included with the first vehicle that has the snow plow. The controller arranges the order of the vehicle system such that the second vehicle is rearward of the first vehicle with the plow. The second vehicle may not even include a snow plow, because the first vehicle will clear the snow from the route in front of the second vehicle. As such, the controller may select the second vehicle without concern for the snow. For example, the controller may select the second vehicle due to desirable performance in cold temperatures, even if the second vehicle is not expected to perform well in snow. As this example illustrates, the controller may select multiple vehicles for combining into a single vehicle system to perform a given mission. The vehicles that are selected may have different equipment from one another, and the controller may select the order of the vehicles in the vehicle system based on the performance relationships between the different equipment and the expected weather conditions to be experienced during the trip/mission.

In an embodiment, the controller may participate in controlling the movement of the vehicles during the missions by modifying the movement of the vehicles based on weather-based fitness considerations. For example, after assigning a vehicle to perform a designated mission, the controller may continue to monitor weather data associated with the path to be taken by the vehicle. Weather forecasts may be inaccurate, and weather conditions can change relatively quickly. Based on updated weather data, the controller may determine that a different weather event is expected along the route during the mission. For example, the vehicle was selected to perform the mission based on an ability of the vehicle to tolerate a first weather event, but the controller now detects that the vehicle will be exposed to a different, second weather event during the trip. The controller may access the VWF table to determine whether the second weather event would detrimentally impact the performance of the vehicle and/or risk equipment failure based on the onboard equipment of the vehicle.

In response to determining that the second weather event represents a risk to the vehicle, the controller takes one or more responsive actions. The controller may generate a control signal to modify movement parameters of the vehicle. The movement parameters may include speed, acceleration, duration of a stop, and the like. For example, the controller may generate a message that instructs the vehicle to change movement parameters to enable the vehicle to temporally avoid the second weather event. In another example, the controller may change the route or path of the mission to enable the vehicle to geographically bypass the second weather event. Other responsive actions may include modifying operation of at least one piece of the equipment onboard the vehicle, notifying an operator of the vehicle about the second weather event, and instructing the operator to install auxiliary equipment on the vehicle. For example, the controller may generate a message that instructs the vehicle controller or operator to deactivate or reduce the operating level of one or more pieces of equipment that may be impacted by the second weather event. Furthermore, if the second weather event is snow or debris on the route and the vehicle includes a plow as auxiliary equipment, the controller may generate a message instructing to installation of the plow on the vehicle.

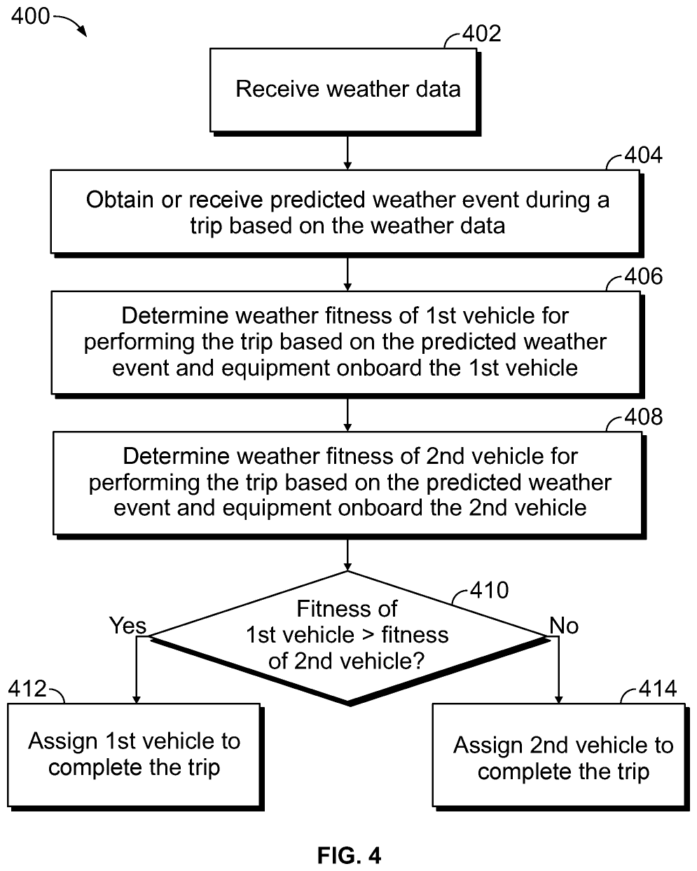

FIG. 4 is a flow chart of a method 400 for evaluating and controlling one or more vehicles based on inclement weather events according to an embodiment. The method may represent the vehicle evaluation and control (VEC) algorithm of the controller in FIG. 2. One or more operations or steps of the method may be performed by the controller shown in FIG. 1 and/or the controller in FIG. 2. The method may include more steps, fewer steps, and/or different steps than shown in FIG. 4.

At step 402, weather data is received. The weather data may be forecasted weather data received from a weather service, actual weather readings measured by weather sensors disposed onboard a vehicle or near a route, or the like. The weather data may be particular to a scheduled trip or mission, such that the weather data is geographically and/or temporally associated with travel of a vehicle during the trip.

At step 404, a predicted weather event is obtained or received. The predicted weather event is along a route during a trip. The weather event is determined based on the weather data. For example, the weather event may be rain, snow, an ice storm, high humidity, low humidity, high temperature, low temperature, particular storm, debris accumulation on the route, flooding, and/or the like.

At step 406, a weather fitness of a first vehicle is determined for performing the trip. The weather fitness is an evaluation value that may be characterized based on the predicted weather event (or weather events) and on the equipment characteristics of equipment disposed onboard the first vehicle. The equipment characteristics of the equipment may include a type of the equipment and a condition of the equipment.

At step 408, a weather fitness of a second vehicle is determined for performing the trip. The second vehicle is discrete from the first vehicle. The first and second vehicles may be two available vehicles in a fleet of vehicles. The weather fitness of the second vehicle is determined based on the predicted weather event(s) and equipment characteristics of equipment disposed onboard the second vehicle.

At step 410, is it determined whether the weather fitness of the first vehicle is greater than the weather fitness of the second vehicle. If the weather fitness of the first vehicle is greater, then that indicates that the first vehicle is more suitable to completing the trip than the second vehicle because the first vehicle is less likely to experience equipment failure and/or delay on the route. If it is determined that the weather fitness of the first vehicle is greater, then flow proceeds to step 412. At step 412, the first vehicle is assigned to complete the trip. As used herein, assigning a vehicle to complete a trip includes assigning the vehicle to perform the trip. The second vehicle is not assigned to complete the trip. If, on the other hand, the weather fitness of the second vehicle is greater than the weather fitness of the first vehicle, then flow proceeds to step 414. At step 414, the second vehicle, rather than the first vehicle, is assigned to complete the trip. As such, the assigning of the first vehicle or the second vehicle to complete the trip is based at least in part on a comparison of the weather fitness of the first vehicle to the weather fitness of the second vehicle.

Optionally, the assigning of the first vehicle or the second vehicle to complete the trip may include generating a fleet schedule that matches multiple vehicles to multiple different missions. For example, the fleet schedule includes an assignment configuration which indicates which vehicle is assigned to each of the trips. The method may include communicating the fleet schedule to the vehicles that are matched to the trips.

The method optionally may include updating the weather fitness of the first vehicle based on a maintenance event performed on at least one piece of the equipment onboard the first vehicle to improve the condition of the equipment.

One or more embodiments disclosed herein may be used to prepare a fleet of vehicles for changing seasons. For example, the vehicle evaluation and control system may be implemented to assist with winterizing a fleet. For example, the controller of the system may review the weather fitness of the vehicles in the fleet to weather events associated with winter such as cold temperature, ice, snow, and low humidity, prior to the winter season starting. The controller may access the VWF table in FIG. 3 to determine which vehicles may be unfit for the winter season. The controller may then schedule maintenance for the unfit vehicles to either change and/or service the onboard equipment for the purpose of improving the weather fitness of those vehicles for the winter season.

In one embodiment, the vehicle evaluation and control system may have a local data collection system deployed that may use machine learning to enable derivation-based learning outcomes. The controller may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

In one embodiment, the controller may include a policy engine that may apply one or more policies. These policies may be based at least in part on characteristics of a given item of equipment or environment. With respect to control policies, a neural network can receive input of a number of environmental and task-related parameters. The neural network can be trained to generate an output based on these inputs, with the output representing an action or sequence of actions for the system. During operation of one embodiment, a determination can occur by processing the inputs through a machine learning/AI process. In one example, the parameters of the neural network may generate a value at the output node designating that action as the desired action. This action may translate into a signal that causes the equipment to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models are obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other.

In an embodiment, a controller of a system includes one or more processors. The controller obtains or receives a predicted weather event along a route during a current or upcoming trip based on weather data. The controller determines a weather fitness of a first vehicle for traveling on the route during the trip based on the predicted weather event and equipment characteristics of equipment disposed onboard the first vehicle. The controller assigns one of the first vehicle or a different, second vehicle to complete the trip based at least in part on the weather fitness of the first vehicle.

Optionally, the controller may determine the weather fitness based at least in part on a performance relationship between the predicted weather event and a type of the equipment onboard the first vehicle. The weather fitness may indicate a predicted ability of the first vehicle to avoid at least one of an equipment failure or a delay when performing the trip. Optionally, the equipment characteristics may include a type of the equipment and a condition of the equipment. The controller may update the weather fitness of the first vehicle based on a maintenance event performed on at least one piece of the equipment to improve the condition of the equipment.

Optionally, the controller may determine a weather fitness of the second vehicle for traveling on the route during the trip based on the predicted weather event and equipment characteristics of equipment disposed onboard the second vehicle. The controller may assign either the first vehicle or the second vehicle to complete the trip based at least in part on a comparison of the weather fitness of the first vehicle to the weather fitness of the second vehicle. The controller may assign either the first vehicle or the second vehicle to complete the trip based on an availability of the first vehicle during a scheduled time period of the trip, a capability of the first vehicle to satisfy trip parameters of the trip, and/or a priority value of the trip relative to at least a second trip.

Optionally, the route is a first route and the trip is a first trip. The controller may obtain or receive a second predicted weather event along a second route during a second trip based on weather data associated with the second route, and determine the weather fitness of the first vehicle for traveling on the second route during the second trip based on the second predicted weather event and the equipment characteristics of the equipment disposed onboard the first vehicle. The controller may assign the first vehicle to complete either the first trip or the second trip based at least in part on the weather fitness of the first vehicle for traveling on the first route during the first trip and the weather fitness of the first vehicle for traveling on the second route during the second trip.

Optionally, the controller may determine the weather fitness of the first vehicle for traveling on the route during the trip by assigning a quantifiable value to the first vehicle. Optionally, the controller may be operably connected to a data storage device that stores vehicle weather fitness data. The vehicle weather fitness data may indicate a plurality of fitness indicia for the first vehicle associated with different corresponding types of weather events. The controller may determine the weather fitness of the first vehicle based at least on one of the fitness indicia for the first vehicle that is associated with the predicted weather event.

Optionally, the controller may obtain or receive the predicted weather event as hot temperature, cold temperature, snow, rain, ice, flooding, debris accumulation, dusty, high humidity, low humidity, and/or high wind. The equipment may include a motor, wheels, an air compressor, a radiator fan, brakes, at least one battery, a plow, an active traction enhancing device, an engine, an inverter assembly, a fuel cell, and/or software for controlling one or more pieces of equipment. The active traction enhancing device may include a rail cleaner nozzle, a snow blower, and/or a sand emitter. Optionally, the first vehicle and the second vehicle are locomotives, and the route is a railroad track.

Optionally, after assigning the first vehicle to complete the trip, responsive to determining different, second predicted weather event along the route during the trip, the controller may generate a control signal to (i) modify movement parameters of the first vehicle, (ii) change the route of the trip, (iii) modify operation of at least one piece of the equipment onboard the first vehicle, (iv) notify an operator of the first vehicle about the second predicted weather event, and/or (v) instruct the operator to install auxiliary equipment on the first vehicle.

In an embodiment, a method is provided for evaluating and controlling one or more vehicles based on inclement weather events. The method includes obtaining or receiving a predicted weather event along a route during a current or upcoming trip based on weather data, and determining, via one or more processors, a weather fitness of a first vehicle for traveling on the route during the trip based on the predicted weather event and equipment characteristics of equipment disposed onboard the first vehicle. The method also includes assigning one of the first vehicle or a different, second vehicle to complete the trip based at least in part on the weather fitness of the first vehicle.

Optionally, the method may include determining a weather fitness of a second vehicle for traveling on the route during the trip based on the predicted weather event and equipment characteristics of equipment disposed onboard the second vehicle. The assigning of the first vehicle or the second vehicle to complete the trip may be based at least in part on a comparison of the weather fitness of the first vehicle and the weather fitness of the second vehicle. Optionally, the assigning of the first vehicle or the second vehicle to complete the trip may include generating a fleet schedule that matches multiple vehicles to multiple different trips and communicating the fleet schedule to the vehicles that are matched to the trips. Optionally, the equipment characteristics of the equipment may include a type of the equipment and a condition of the equipment. The method may include updating the weather fitness of the first vehicle based on a maintenance event performed on at least one piece of the equipment to improve the condition of the equipment.

In an embodiment, a system is provided including a controller having one or more processors. The controller obtains or receives a predicted weather event along a route during a trip based on weather data and trip parameters, and determines a weather fitness of a vehicle for traveling on the route during the trip based on the predicted weather event and equipment characteristics of equipment disposed onboard the first vehicle. The weather fitness indicates a predicted ability of the vehicle to avoid at least one of an equipment failure or a delay when performing the trip. The controller assigns the vehicle to complete the trip based at least in part on the weather fitness of the vehicle. During the trip, in response to determining a different, second predicted weather event that the vehicle is expected to experience during the trip, the controller generates a control signal. The control signal is generated to (i) modify movement parameters of the first vehicle, (ii) change the route of the trip, (iii) modify operation of at least one piece of the equipment onboard the first vehicle, (iv) notify an operator of the vehicle about the second predicted weather event, and/or (v) instruct the operator to install auxiliary equipment on the vehicle.

Optionally, the system includes a data storage device operably connected to the controller and configured to store vehicle weather fitness data. The vehicle weather fitness data may indicate a plurality of fitness indicia for the first vehicle associated with different corresponding types of weather events. The controller may determine the weather fitness of the vehicle based at least on one of the fitness indicia for the vehicle that is associated with the predicted weather event.

As used herein, the terms “processor” and “computer,” and related terms, e.g., “processing device,” “computing device,” and “controller” may be not limited to just those integrated circuits referred to in the art as a computer, but refer to a microcontroller, a microcomputer, a programmable logic controller (PLC), field programmable gate array, and application specific integrated circuit, and other programmable circuits. Suitable memory may include, for example, a computer-readable medium. A computer-readable medium may be, for example, a random-access memory (RAM), a computer-readable non-volatile medium, such as a flash memory. The term “non-transitory computer-readable media” represents a tangible computer-based device implemented for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. As such, the term includes tangible, computer-readable media, including, without limitation, non-transitory computer storage devices, including without limitation, volatile and non-volatile media, and removable and non-removable media such as firmware, physical and virtual storage, CD-ROMS, DVDs, and other digital sources, such as a network or the Internet.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A controller, comprising one or more processors configured to:
obtain or receive a predicted weather event along a route during a current or upcoming trip based on weather data;
determine a weather fitness of a first vehicle for traveling on the route during the trip based on the predicted weather event and equipment characteristics of equipment disposed onboard the first vehicle; and
assign one of the first vehicle or a different, second vehicle to complete the trip based at least in part on the weather fitness of the first vehicle.

2. The controller of claim 1, wherein the controller is configured to determine the weather fitness based at least in part on a performance relationship between the predicted weather event and a type of the equipment onboard the first vehicle, the weather fitness indicating a predicted ability of the first vehicle to avoid at least one of an equipment failure or a delay when performing the trip.

3. The controller of claim 1, wherein the equipment characteristics include a type of the equipment and a condition of the equipment.

4. The controller of claim 3, wherein the controller is configured to update the weather fitness of the first vehicle based on a maintenance event performed on at least one piece of the equipment to improve the condition of the equipment.

5. The controller of claim 1, wherein the controller is further configured to determine a weather fitness of the second vehicle for traveling on the route during the trip based on the predicted weather event and equipment characteristics of equipment disposed onboard the second vehicle, and the controller is configured to assign one of the first vehicle or the second vehicle to complete the trip based at least in part on a comparison of the weather fitness of the first vehicle to the weather fitness of the second vehicle.

6. The controller of claim 1, wherein the controller is configured to assign one of the first vehicle or the second vehicle to complete the trip based on one or more of an availability of the first vehicle during a scheduled time period of the trip, a capability of the first vehicle to satisfy trip parameters of the trip, or a priority value of the trip relative to at least a second trip.

7. The controller of claim 1, wherein the route is a first route and the trip is a first trip, the controller further configured to:
obtain or receive a second predicted weather event along a second route during a second trip based on weather data associated with the second route;
determine the weather fitness of the first vehicle for traveling on the second route during the second trip based on the second predicted weather event and the equipment characteristics of the equipment disposed onboard the first vehicle; and
assign the first vehicle to complete one of the first trip or the second trip based at least in part on the weather fitness of the first vehicle for traveling on the first route during the first trip and the weather fitness of the first vehicle for traveling on the second route during the second trip.

8. The controller of claim 1, wherein the controller is configured to determine the weather fitness of the first vehicle for traveling on the route during the trip by assigning a quantifiable value to the first vehicle.

9. The controller of claim 1, wherein the controller is configured to be operably connected to a data storage device that stores vehicle weather fitness data, the vehicle weather fitness data indicating a plurality of fitness indicia for the first vehicle associated with different corresponding types of weather events, the controller configured to determine the weather fitness of the first vehicle based at least on one of the fitness indicia for the first vehicle that is associated with the predicted weather event.

10. The controller of claim 1, wherein the controller is configured to obtain or receive the predicted weather event as one or more of: hot temperature, cold temperature, snow, rain, ice, flooding, debris accumulation, dusty, high humidity, low humidity, or high wind.

11. The controller of claim 1, wherein the equipment includes one or more of a motor, wheels, an air compressor, a radiator fan, brakes, at least one battery, a plow, an active traction enhancing device, an engine, an inverter assembly, a fuel cell, or software for controlling one or more pieces of equipment.

12. The controller of claim 11, wherein the active traction enhancing device includes one or more of a rail cleaner nozzle, a snow blower, or a sand emitter.

13. The controller of claim 1, wherein, after assigning the first vehicle to complete the trip, responsive to determining different, second predicted weather event along the route during the trip, the controller is configured to generate a control signal to one or more of modify movement parameters of the first vehicle, change the route of the trip, modify operation of at least one piece of the equipment onboard the first vehicle, notify an operator of the first vehicle about the second predicted weather event, or instruct the operator to install auxiliary equipment on the first vehicle.

14. The controller of claim 1, wherein the first vehicle and the second vehicle are locomotives and the route is a railroad track.

15. A method, comprising:
obtaining or receiving a predicted weather event along a route during a current or upcoming trip based on weather data;
determining, via one or more processors, a weather fitness of a first vehicle for traveling on the route during the trip based on the predicted weather event and equipment characteristics of equipment disposed onboard the first vehicle; and
assigning one of the first vehicle or a different, second vehicle to complete the trip based at least in part on the weather fitness of the first vehicle.

16. The method of claim 15, further comprising:
determining a weather fitness of a second vehicle for traveling on the route during the trip based on the predicted weather event and equipment characteristics of equipment disposed onboard the second vehicle,
wherein the assigning of the first vehicle or the second vehicle to complete the trip is based at least in part on a comparison of the weather fitness of the first vehicle and the weather fitness of the second vehicle.

17. The method of claim 15, wherein the assigning of the first vehicle or the second vehicle to complete the trip comprises generating a fleet schedule that matches multiple vehicles to multiple different trips and communicating the fleet schedule to the vehicles that are matched to the trips.

18. The method of claim 15, wherein the equipment characteristics of the equipment include a type of the equipment and a condition of the equipment, and the method further comprises updating the weather fitness of the first vehicle based on a maintenance event performed on at least one piece of the equipment to improve the condition of the equipment.

19. A system, comprising:
a controller including one or more processors, the controller configured to:
obtain or receive a predicted weather event along a route during a trip based on weather data and trip parameters;
determine a weather fitness of a vehicle for traveling on the route during the trip based on the predicted weather event and equipment characteristics of equipment disposed onboard the first vehicle, the weather fitness indicating a predicted ability of the vehicle to avoid at least one of an equipment failure or a delay when performing the trip;
assign the vehicle to complete the trip based at least in part on the weather fitness of the vehicle; and
wherein, during the trip, responsive to determining a different, second predicted weather event that the vehicle is expected to experience during the trip, the controller is configured to generate a control signal to one or more of modify movement parameters of the first vehicle, change the route of the trip, modify operation of at least one piece of the equipment onboard the first vehicle, notify an operator of the vehicle about the second predicted weather event, or instruct the operator to install auxiliary equipment on the vehicle.

20. The system of claim 19, further comprising a data storage device operably connected to the controller and configured to store vehicle weather fitness data, the vehicle weather fitness data indicating a plurality of fitness indicia for the first vehicle associated with different corresponding types of weather events, the controller configured to determine the weather fitness of the vehicle based at least on one of the fitness indicia for the vehicle that is associated with the predicted weather event.
